(19) United States
(12) Patent Application Publication
(10) Pub. No.: US 2001/0027416 A1
(43) Pub. Date: Oct. 4, 2001

(54) Method of attracting customers in bulletin board and system using bulletin board

(76) Inventor: Koji Nakamura, Tokyo (JP)

Correspondence Address: McGuire Woods, 1750 Tysons Boulevard, Tysons Corner, Suite 1800, McLean, VA, 22102-4215, US

(21) Appl. No.: 09/816,230

(22) Filed: Mar. 26, 2001

(30) Foreign Application Priority Data
Mar. 31, 2000 (JP) 2000-098830

(51) Int. Cl. G06F 17/60

(52) U.S. Cl. 705/14

(57) ABSTRACT

When a client connected to a server via the Internet contributes an article to a bulletin board supplied from a server, another client that has seen the article evaluates the article, and enters the evaluation in the bulletin board. For example, the other client votes for or against the contributed article. Depending on the evaluation, the client that has contributed the article is given a certain benefit. If the other client votes for or against the article, then the client that has contributed the article is given a benefit depending on the number or proportion of votes for the article. The client that has evaluated the article is also given a certain benefit depending on the number of reactions to the article in the bulletin board, i.e., the number of times that the evaluation is entered.

### BACKGROUND OF THE INVENTION

1. Field of the Invention

The present invention relates to a method of attracting customers in a bulletin board, and a system which uses a bulletin board.

2. Description of the Related Art

Today, the Internet and personal computers are quickly finding their way into homes, so that individuals can easily connect to the Internet anytime and anywhere. It is customary for companies to set up home pages in the Internet to provide their information and sell their goods and services through the home pages.

Those home pages are required to have a customer attracting capability for increasing an advertisement effect for the companies and their goods displayed in the home pages. Such a customer attracting capability is generally provided by information providing services including a bulletin board system and a chat system based on e-mail and World Wide Web (hereinafter referred to as “WWW”).

The bulletin board system, which is one of the above information providing services, is used by users who contribute opinions about desired goods and users who contribute opinions or criticisms about the contributed opinions. When users use the bulletin board system, they are provided with information about goods by seeing advertisements on pages and opinions written by other users.

As shown in FIG. 1 of the accompanying drawings, a conventional bulletin board system comprises a plurality of clients 101-1-101-n such as personal computers operated by individuals, information transmitting server 102 owned by a company, for example, and connected to clients 101-1-101-n via Internet 111, and article database 105 for storing articles contributed to the bulletin board system. Information transmitting server 102 has bulletin board display form 104 prepared in advance using a description language such as HTML.

In the bulletin board system shown in FIG. 1, when a request for displaying a bulletin board is transmitted from client 101-1, for example, to information transmitting server 102 using a WWW browser, bulletin board display form 104 and information stored in article database 105 are combined with each other by bulletin board system program 103 that is run by information transmitting server 102, and transmitted as bulletin board rendering data to client 101-1.

Client 101-1 can browse the bulletin board rendering data transmitted from information transmitting server 102 using the WWW browser.

For making a contribution from client 101-1 to the bulletin board, information representing characters and graphics is entered into a contribution box displayed in the WWW browser of client 101-1, and the entered information is transmitted to information transmitting server 102.

The information transmitted to information transmitting server 102 is written into article database 105 by bulletin board system program 103, and the updated information in article database 105 and bulletin board display form 104 are combined with each other and transmitted as bulletin board rendering data to client 101-1.

When the updated rendering data is received by client 101-1, the displayed image of the WWW browser is renewed.

As described above, the program for displaying the bulletin board is stored in advance in information transmitting server 102. When a request for the transmission of information is sent from clients 101-1-101-n to information transmitting server 102, bulletin board rendering data is transmitted from information transmitting server 102 to clients 101-1-101-n, which display the bulletin board rendering data transmitted from information transmitting server 102.

In the conventional bulletin board system, however, since users find little advantages to contribute to the bulletin board, many users usually do nothing other than reading messages on the bulletin board. Another problem is that because there are few interesting contributions providing sufficient information about goods for sale, the advertisement effect of the bulletin board is not strong enough.

### SUMMARY OF THE INVENTION

It is an object of the present invention to provide a method of attracting customers in a bulletin board with an increased capability to attract customers to a home page using the bulletin board, and a system which uses a bulletin board.

In order to accomplish the above objects, it is necessary to increase the incentive of the user to contribute to the bulletin board and help the user intend to contribute significant information that is interesting. Some effective means for satisfying the above requirements will be considered below.

Heretofore, it has been customary to promote consumer's incentive to purchase merchandise by assigning points to the customer when the customer has purchased merchandise, and discounting merchandise to be purchased next time or applying for a premium depending on the number of assigned points.

The above principles may be applied to contributions made to the bulletin board by assigning points to a contribution that is made to the bulletin board depending on its content and discounting merchandise to be purchased next time or applying for a premium depending on the number of assigned points. With this arrangement, it is expected that the number of contributions to the bulletin board will be increased, and the number of significant contributions that are interesting will be increased.

The content of the contribution to the bulletin board may be evaluated by the administrator of the bulletin board, and points depending on the evaluation may be assigned to the contributor. According to such a process, however, a lot of labor and cost would be needed because the administrator is required to read and evaluate the contributed articles one by one. In addition, since the evaluation reflects a certain subjective aspect of the administrator, the evaluation may possibly differ from the evaluations of users, who may cast doubt on the reliability of the evaluation.

According to the present invention, when a client connected to a server via the Internet contributes an article to a bulletin board supplied from the server, another client which has seen the article evaluates the article, and enters the evaluation in the bulletin board. For example, the other client votes for or against the contributed article. Depending on the evaluation, the client that has contributed the article is given a certain benefit. If the other client votes for or against the article, then the client that has contributed the article is given a benefit depending on the number or proportion of votes for the article. The client that has evaluated the article is also given a certain benefit depending on the number of reactions to the article in the bulletin board, i.e., the number of times that the evaluation is entered.

Inasmuch as the client is given a benefit depending on the contribution of an article to the bulletin board and a reaction to the contribution, the number of times that the client uses the bulletin board increases. Therefore, home pages with the bulletin board have an increased customer attracting capability, resulting in an increased advertisement effect for goods or services displayed on the home pages and companies or goods or services using the bulletin board.

Inasmuch as an evaluation of a contributed article, which serves as a criterion for giving a benefit, is made by another client who has seen the bulletin board, the article can be evaluated without a large expenditure of labor and cost. Moreover, the evaluation is less likely to reflect a subjective aspect of the administrator of the bulletin board, and the clients have an increased motivation for making contributions to the bulletin board.

If a page with the bulletin board displayed therein is combined with a page for purchasing merchandise, then more opportunities are available for the user to purchase merchandise with a reduced expenditure of cost and labor.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram of a conventional bulletin board system;

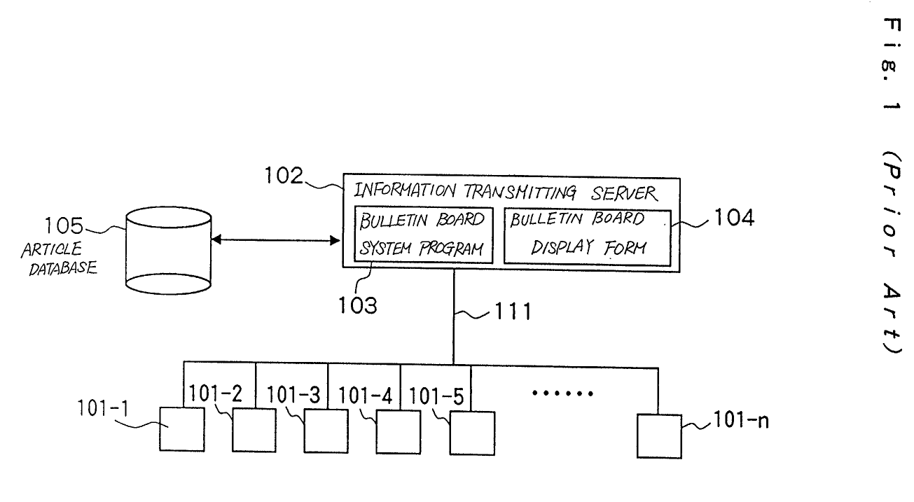

FIG. 2 is a block diagram of a system which uses a bulletin board according to the present invention;

FIG. 3 is a flowchart of a processing sequence to inquire a customer ID in the system shown in FIG. 2;

FIG. 4 is a flowchart of a processing sequence to contribute to the bulletin board in the system shown in FIG. 2;

FIG. 5 is a diagram showing a record table in an article database in the system shown in FIG. 2;

FIG. 6 is a flowchart of a processing sequence to vote on an article displayed on the bulletin board in the system shown in FIG. 2;

FIG. 7 is a flowchart of a processing sequence to add points for a customer in the system shown in FIG. 2;

FIG. 8 is a diagram showing a record table in a customer information database in the system shown in FIG. 2; and

FIG. 9 is a flowchart of another processing sequence to add points for a customer in the system shown in FIG. 2.

### DETAILED DESCRIPTION OF THE PREFERRED EMBODIMENT

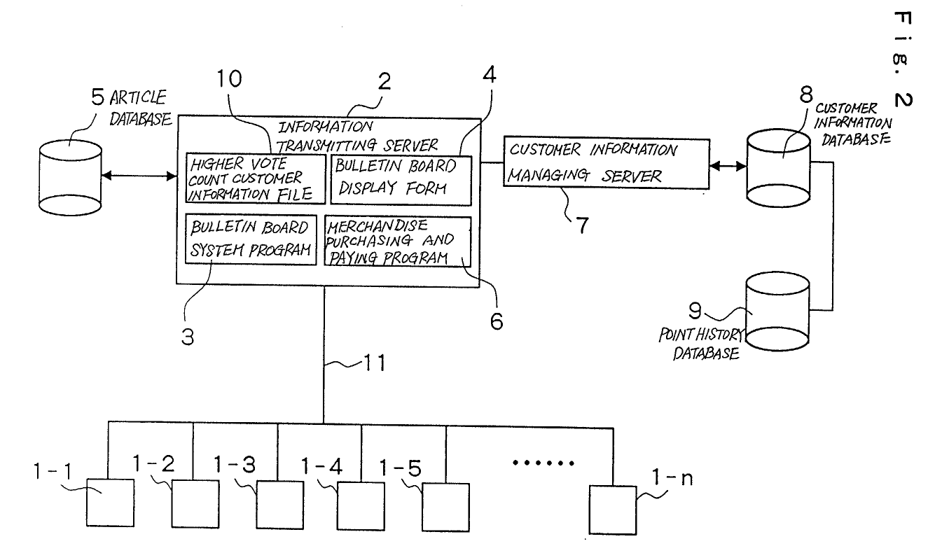

As shown in FIG. 2, a system which uses a bulletin board according to the present invention comprises a plurality of clients 1-1-1-n such as personal computers operated by individuals, information transmitting server 2 connected to clients 1-1-1-n via Internet 11 for transmitting bulletin board rendering data to clients 1-1-1-n, an article database 5 for storing articles contributed to the bulletin board system, customer information database 8 for storing customer information, customer information managing server 7 for managing the customer information stored in customer information database 8, a point history database 9 for storing a history of the addition of points for customers.

Information transmitting server 2 has bulletin board display form 4 prepared using a description language such as HTML, merchandise purchasing and paying program 6 for purchasing and paying for goods, bulletin board program 3 for displaying a bulletin board, and higher vote count customer information file 10 for sorting out a list of customers who have voted on an article displayed in the bulletin board, according to the number of votes, and recording only customers with higher vote counts. Added points for contributors and voters for the bulletin board are also calculated by bulletin board program 3.

If a customer has used points for discounting goods to be purchased or applying for a premium, then customer information managing server 7 subtracts the used points from present points of the corresponding customer information among the customer information that is stored in customer information database 8.

Point history database 9 is linked to the customer information stored in customer information database 8, so that any customer can see its own point history anytime when the bulletin board is displayed.

While customer information managing server 7 is provided for managing customer information in the present embodiment, information transmitting server 2 for transmitting a display form may be arranged to have a function equivalent to that of customer information managing server 7, so that information transmitting server 2 and customer information managing server 7 can be combined into a single server. In the present embodiment, the Internet is used to interconnect clients 1-1-1-n, it may be replaced with an intranet.

A process of using the bulletin board in the above system will be described below.

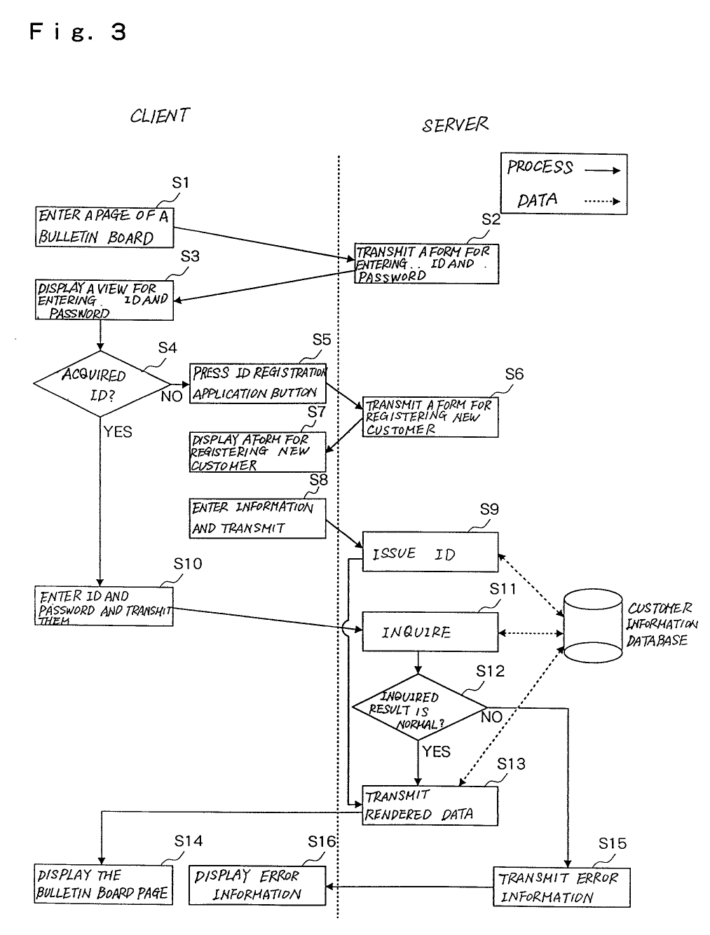

First, a processing sequence to inquire a customer ID in the system shown in FIG. 2 will be described below with reference to FIG. 3.

If a request to enter a page in which a bulletin board is present is sent from clients 1-1-1-n via the network 11 in step S1, information transmitting server 2 transmits a form for entering a customer ID and a password to clients 1-1-1-n in step S2. In step S3, a view for entering a customer ID and a password is displayed on clients 1-1-1-n.

If the user has not yet acquired a customer ID in step S4, then the user presses an ID registration application button displayed on the WWW browser in step S5.

When the ID registration application button is pressed, information transmitting server 2 transmits a form for registering a new customer to clients 1-1-1-n in step S6.

The form for registering a new customer which has been transmitted from information transmitting server 2 is displayed on clients 1-1-1-n in step S7. In step S8, the user enters information according to the form and transmits the entered information.

The information transmitted from clients 1-1-1-n is received by customer information managing server 7. In step S9, the received information is written in customer information database 8, and returned with an added unique ID to clients 1-1-1-n. Subsequently, the user requests information transmitting server 2 to display a bulletin board using the given customer ID.

If the user has already acquired a customer ID in step S4, then the user enters the customer ID and the password into the form, and transmits them to information transmitting server 2 in step S10.

When information transmitting server 2 has received the customer ID and the password, information transmitting server 2 requests customer information managing server 7 to inquire the customer information using the customer ID and the password which have been received.

In step S11, customer information managing server 7 inquires the corresponding customer information among the customer information stored in customer information database 8, and transmits the inquired result to information transmitting server 2.

If the inquired result is normal, i.e., the association between the customer ID and the password that have been entered agrees with the association between the customer ID and the password that are stored in customer information database 8, in step S12, then information transmitting server 2 transmits rendered data of the page of the bulletin board to clients 1-1-1-n in step S13. In step S14, the WWW browser in clients 1-1-1-n displays the bulletin board page.

If the inquired result is normal, then information transmitting server 2 which transmits rendered data of the page form accesses customer information managing server 7, and customer information managing server 7 extracts the corresponding customer information from customer information database 8. Information transmitting server 2 adds the number of points that are presently owned by the customer to the rendering data to be transmitted to clients 1-1-1-n, and transmits the rendering data with the added number of points.

Now, clients 1-1-1-n can display the number of points that are presently owned thereby on the page at all times.

If the inquired result is not normal, e.g., if the passwords do not match each other, in step S12, then information indicating that the inquired result is not normal is transmitted to clients 1-1-1-n in step S15. In step S16, clients 1-1-1-n display the transmitted information.

The password can always be changed in the form for entering a customer ID and a password. In the present embodiment, the password is required in order to prevent persons other than the customer from unduly adding points. The system may be arranged such that the customer ID is not to be checked when entering a page in which a bulletin board is present, and the customer ID and the password are to be entered when making a contribution or a vote to the bulletin board.

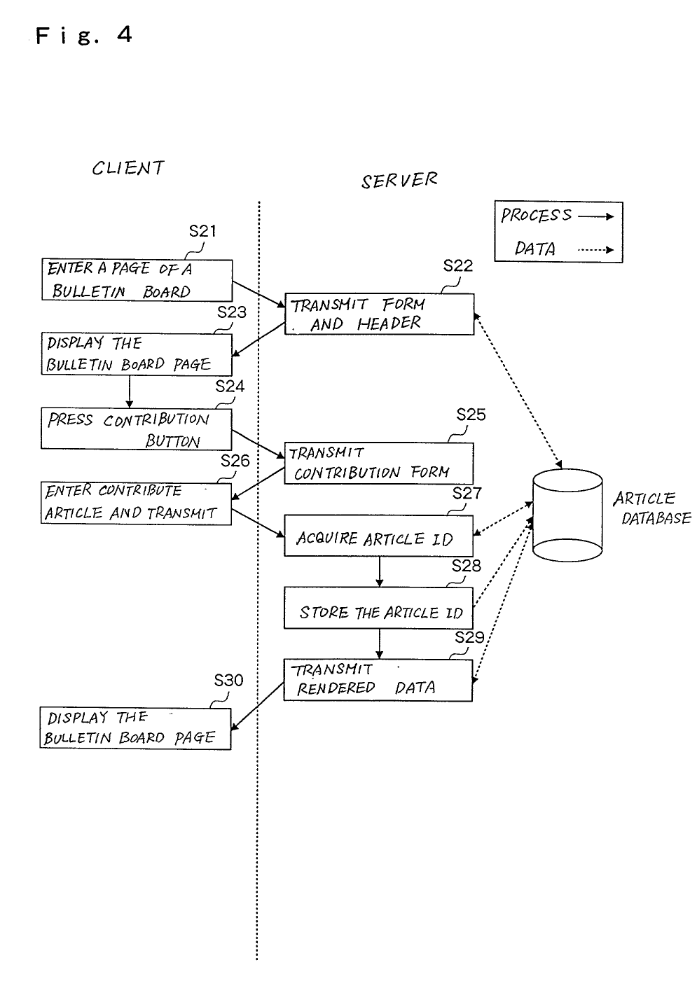

A processing sequence to contribute to the bulletin board in the system shown in FIG. 2 will be described below with reference to FIG. 4.

If a request to enter a page in which a bulletin board is present is sent from clients 1-1-1-n via the network 11 in step S21, the process of inquiring the customer ID and the password as shown in FIG. 3 is carried out. Thereafter, in step S22, information transmitting server 2 transmits bulletin board display form 4 and rendering data of existing article headers to clients 1-1-1-n.

In step S23, the WWW browser in clients 1-1-1-n displays a list of article titles and headlines.

Thereafter, when the contributor presses a bulletin board contribution button displayed in clients 1-1-1-n in step S24, information transmitting server 2 transmits rendering data of a bulletin board contribution form to clients 1-1-1-n in step S25.

In step S26, the contributor enters a contributed article in the bulletin board contribution form transmitted from information transmitting server 2, and transmits the contributed article in the bulletin board contribution form to information transmitting server 2.

When information transmitting server 2 receives the contributed article transmitted from clients 1-1-1-n, bulletin board program 3 run by information transmitting server 2 acquires an unassigned article ID from article database 5 in step S27. In step S28, the contributed article is stored in association with the acquired article ID in article database 5.

Thereafter, information transmitting server 2 transmits rendering data of information including the contributed articles to clients 1-1-1-n in step S29. In step S30, clients 1-1-1-n displays the updated bulletin board.

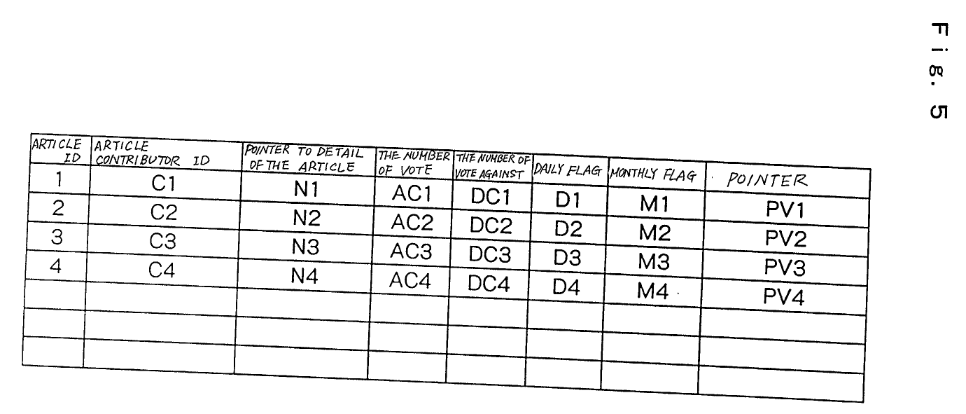

A record table in article database 5 will be described below with reference to FIG. 5.

As shown in FIG. 5, each of the contributed articles is associated with an article ID, the ID of the article contributor, a pointer to details of the article, the number of votes for and the number of votes against the article (to be described later on), a Daily flag, a Monthly flag, and a pointer to a list of IDS of contributors who have voted on the article.

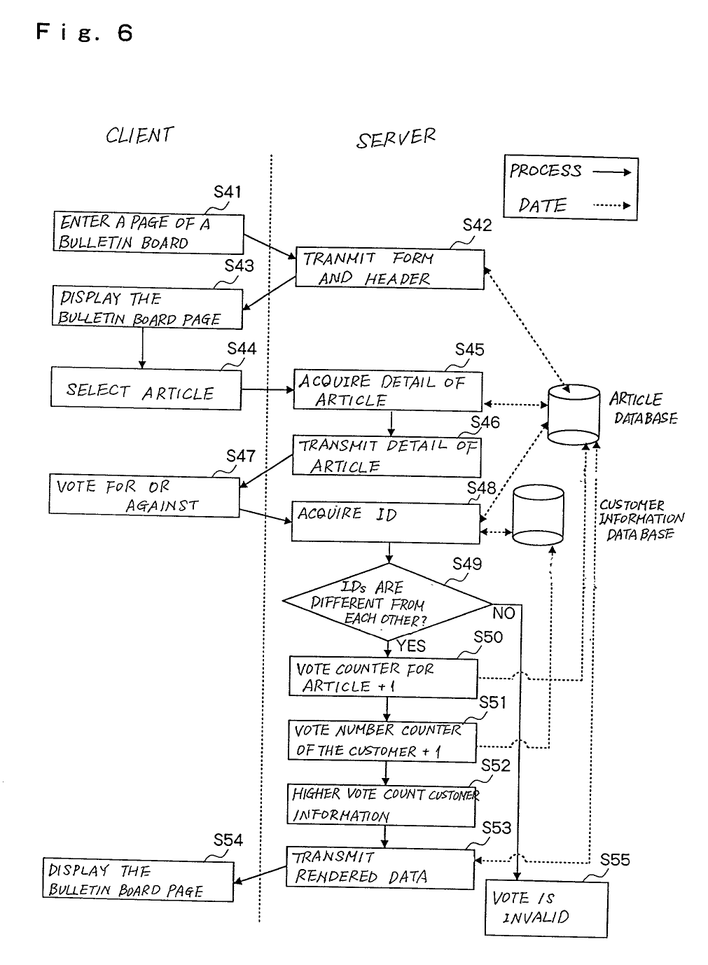

A processing sequence to contribute to the bulletin board in the system shown in FIG. 2 will be described below with reference to FIG. 6.

If a request to enter a page in which a bulletin board is present is sent from clients 1-1-1-n via the network 11 in step S41, the process of inquiring the customer ID and the password as shown in FIG. 3 is carried out. Thereafter, in step S42, information transmitting server 2 transmits bulletin board display form 4 and rendering data of existing article headers to clients 1-1-1-n.

In step S43, the WWW browser in clients 1-1-1-n displays a list of article titles and headlines.

Thereafter, when the voter selects an article to be read from the list displayed in clients 1-1-1-n in step S44, bulletin board program 3 run by information transmitting server 2 acquires details of the corresponding article among the articles stored in article database 5, and transmits the acquired details together with bulletin board display form 4 to clients 1-1-1-n in step S46. Bulletin board display form 4 transmitted at this time has buttons to be used by readers to vote for and against the article and a field for indicating the number of votes for and the number of votes against the article in the form of a number or a graph. As shown in FIG. 5, the number of votes for and the number of votes against the article are contained in the record table in article database 5 for each of articles. The rendering data transmitted to clients 1-1-1-n includes the numerical values recorded in the record table. Therefore, the WWW browser in clients 1-1-1-n displays the content of the selected article, the buttons to vote for and against the article, and the present status of votes for and against the article.

If a reader wants to contribute an opinion about the article displayed on the bulletin board, the contribution is made according to the processing sequence shown in FIG. 4.

If the voter only votes for or against the displayed article, then when the voter presses one of the buttons in clients 1-1-1-n in step S47, bulletin board program 3 run by information transmitting server 2 acquires the customer ID of the article contributor in step s48.

In step S49, the customer ID of the voter and the acquired customer ID of the article contributor are compared with each other. If the compared customer IDs are different from each other, one vote for or against the article is added to a vote counter for the article in article database 5 in step S50. In step S51, customer information managing server 7 adds 1 to a vote number counter of the customer who has voted, among the customer information stored in customer information database 8, thus updating the number of votes. In step S52, higher vote count customer information file 10 is updated.

Thereafter, in step S53, the updated rendering data is transmitted from information transmitting server 2 to clients 1-1-1-n. In step S54, clients 1-1-1-n display the updated bulletin board.

If the customer ID of the voter and the customer ID of the contributor agree with each other in step S49, then the vote is judged as invalid, and the processing sequence is put to an end in step S55.

The customer ID of the voter and the customer ID of the contributor are compared with each other in step S49 in order to prevent a contributor from unduly voting for its own article for the purpose of gaining points. To prevent a voter from taking multiple votes on one article, the IDs of voters are registered with respect to the articles stored in article database 5, and if the customer ID of a voter has already been registered as the customer ID of the voter for an article in article database 5, then the vote is judged as a multiple vote and will not be added. Other than the above process of registering customer IDs in article database 5, there may be employed a process of eliminating undue votes from contributors and voters by determining and controlling customers using an information managing file, which is called cookie, stored in the WWW browser. This process is advantageous in that the record size in article database 5 can be reduced.

As described above, since readers can take part in the activities of the bulletin board simply by pressing buttons without having to make contributions to the bulletin board, the participation of a large number of customers can be expected. Because the status of votes for and against articles is available, contributors are automatically prompted to make contributions that are interesting and significant.

In the present embodiment, voters vote for or against articles. However, the system according to the present invention may be arranged for voters to vote on an article by selecting multiple values or evaluating the article with points.

Processing sequences to add points for a customer in the system shown in FIG. 2 will be described below.

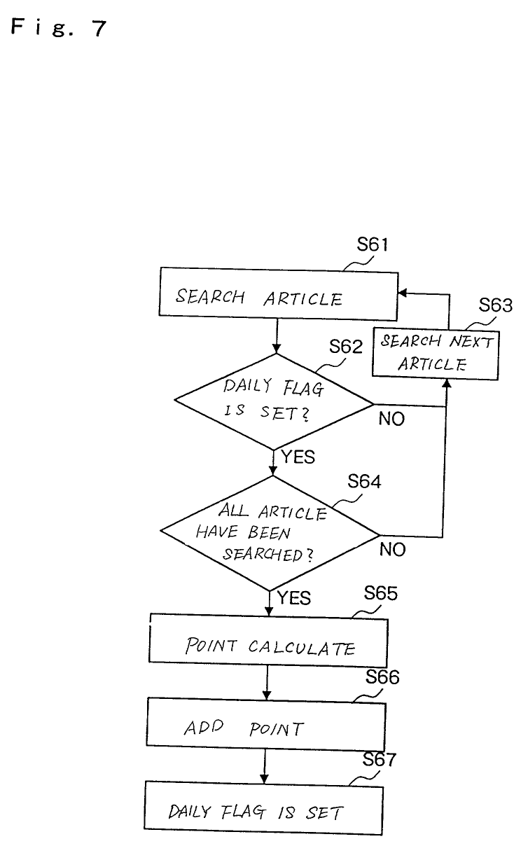

First, a processing sequence to add points for a contribution per day will be described below with reference to FIG. 7.

In step S61, information transmitting server 2 searches article database 5 at a predetermined time everyday for an article that has passed beyond a certain period from the day on which the article was contributed.

In step S62, the status of the Daily flag (see FIG. 5) of the article that has been found is confirmed. If the Daily flag is set, then the article is skipped as an invalid article, and a next article is searched for in step S63.

If the Daily flag is not set, then the article is extracted as an article to be processed. In step S64, it is determined whether all the registered articles have been searched for or not. If not, then control goes back to step S63 to search for a next article.

If all the registered articles have been searched for, then the points gained of the contributor of the extracted article are calculated from the recorded numbers of votes for and against the article according to a predetermined equation in step S65.

Examples of such a predetermined equation are given as follows:

Acquired points=|number of votes for the article−number of votes against the article|

Acquired points=number of votes for the article/100

Using the customer ID whose article has gained points calculated as described above as a keyword, the corresponding customer information is retrieved from customer information database 8. The presently acquired points are then added to the record of the number of points for the customer, thus updating the number of points in step S66.

Thereafter, in step S67, the Daily flag is set for all the extracted articles, thereby preventing from those articles from being extracted in subsequent days.

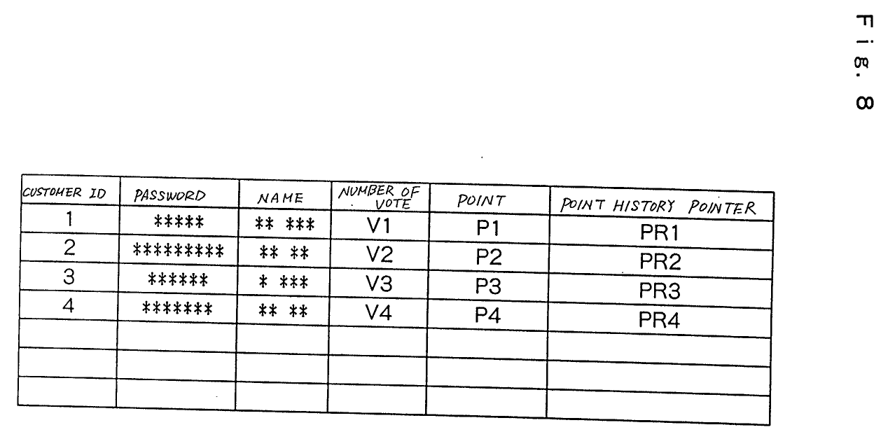

A record table in customer information database 8 will be described below with reference to FIG. 8.

As shown in FIG. 8, customer information database 8 has customer IDs of the respective customers, and contains, for each of the customer IDs, a password and a name of the customer, the number of votes for a contributed article, the present number of points assigned to the customer, and a point history pointer for searching point history database 9. The number of points is updated by the processing in step S66 shown in FIG. 7.

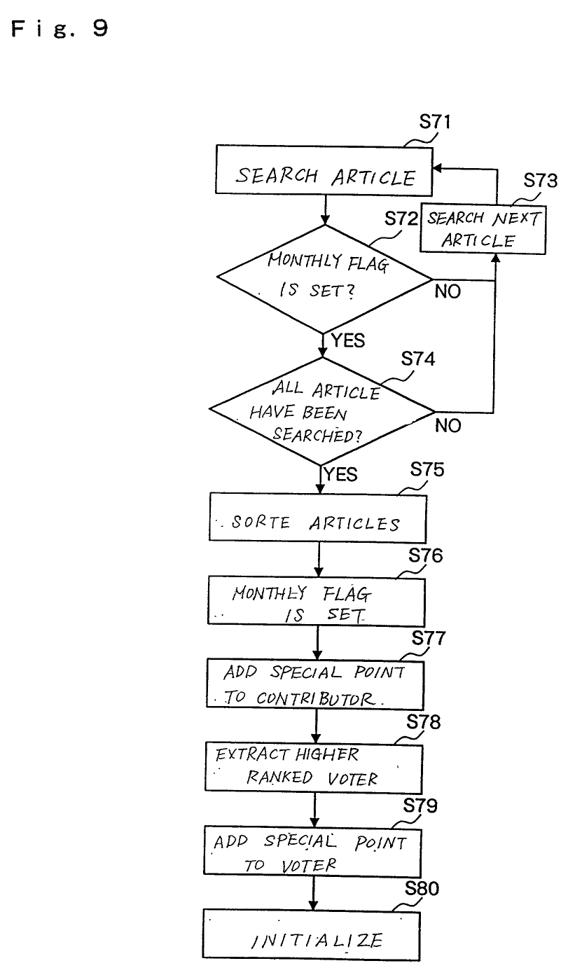

A processing sequence to add points for a contribution per month will be described below with reference to FIG. 9.

In step S71, information transmitting server 2 searches article database 5 at a predetermined time on a predetermined day every month for an article that has been contributed in the past month.

In step S72, the status of the Monthly flag (see FIG. 5) of the article that has been found is confirmed. If the Monthly flag is set, then the article is skipped as an invalid article, and a next article is searched for in step S73.

If the Monthly flag is not set, then the article is extracted as an article to be processed. In step S74, it is determined whether all the registered articles have been searched for or not. If not, then control goes back to step S73 to search for a next article.

If all the registered articles have been searched for, then the numbers of votes for the extracted articles are compared with each other, and the extracted articles are sorted out in a descending order of the numbers of votes for them in step S75.

In step S76, the Monthly flag is set for all the extracted articles, thereby preventing from those articles from being extracted in subsequent months.

Using the customer IDs whose contributed articles in higher ranks among the extracted and sorted-out articles as a keyword, the corresponding customer information is retrieved from customer information database 8. Predetermined special points are then added to the record of the number of points for the customer (see FIG. 8), thus updating the number of points in step S77.

In step S78, the customer ID of the voter who has been ranked as a higher vote count customer is extracted from higher vote count customer information file 10. In step S79, the customer information is retrieved from customer information database 8 using the extracted customer ID as a keyword, and predetermined points are added to the record of the number of points for the customer, thus updating the number of points.

Thereafter, in step S80, the records of the vote counts of all the customers present in customer information database 8 are initialized to 0.

In the present embodiment, the period for adding points is set to one month. However, the period for adding points may be changed to any desired period. In the embodiment, points are added if a contributor gains the greatest number of votes for the contributed article, and points are added if a voter gains the greatest number of votes. Such point adding criteria are by way of example only and may be modified. For example, points may be added if a contributor has made the greatest number of contributions during the given period, and points may be added if a voter has made the greatest number of accesses to the bulletin board.

There are available a plurality of bulletin boards for respective predetermined categories, and the user can select the bulletin board for any desired category.

The above page of the bulletin board may possibly be displayed following pages containing various information after the home page has been accessed. In such a case, the advertisements displayed in the intervening pages until the page of the bulletin board is displayed are available to the user.

If the page of the bulletin board is linked to a page for purchasing goods or services, then the user is given increased opportunities for purchasing goods or services with a small expenditure of cost and labor.

According to the present invention, depending on the evaluation by a client of an article contributed to the bulletin board, the client who has contributed the article is given a certain benefit, which is liable to increase the number of positive contributions to the bulletin board. Therefore, home pages with the bulletin board have an increased customer attracting capability, resulting in an increased advertisement effect for goods or services displayed on the home pages and companies or goods or services using the bulletin board. Furthermore, the number of significant contributions that attract other clients is increased. Clients are given more opportunities to know goods or services offered for sake, and an increased incentive to buy goods or services.

Depending on the number of reactions to the bulletin board from clients with respect a contributed article, i.e., the number of evaluations entered with respect a contributed article, the clients who have evaluated the article are given a certain benefit. This offers the same advantages as those described above.

Inasmuch as an evaluation of a contributed article, which serves as a criterion for giving a benefit, is made by another client who has seen the bulletin board, the article can be evaluated in a fair environment without a large expenditure of labor and cost. In addition, the number of significant contributions that are interesting to other clients will be increased.

If a client evaluates a contributed article by voting for or against the article, then since the evaluation of the article is easy and clear, the number of clients whose evaluate contributed articles will be increased, resulting in more users of the Internet.

If the page in which the bulletin board is displayed is combined with a page for purchasing goods or services, then the user is given increased opportunities for purchasing goods or services with a small expenditure of cost and labor.

While a preferred embodiment of the present invention has been described using specific terms, such description is for illustrative purposes only, and it is to be understood that changes and variations may be made without departing from the spirit or scope of the following claims.

What is claimed is:

1. A method of attracting customers in a bulletin board supplied from a server connected to a plurality of clients, comprising the step of:
giving a client a predetermined benefit depending on the level of a reaction from another client with respect to an article which has been contributed to the bulletin board by said client.

2. A method of attracting customers in a bulletin board, comprising the steps of:
storing an article contributed to a bulletin board supplied to a client in a server from a plurality of clients;
supplying the article stored in the server to another client; and
giving the client which has contributed the article a predetermined benefit depending on the level of a reaction from said other client with respect to said article.

3. A method according to claim 1, wherein said reaction from the other client serves as a criterion to give the client said benefit comprises an evaluation made by said other client with respect to said article.

4. A method according to claim 2, wherein said reaction from the other client serves as a criterion to give the client said benefit comprises an evaluation made by said other client with respect to said article.

5. A method according to claim 3, wherein said criterion to give the client said benefit comprises a quantitative value depending on the number of answers from clients which have evaluated the article.

6. A method according to claim 4, wherein said criterion to give the client said benefit comprises a quantitative value depending on the number of answers from clients which have evaluated the article.

7. A method according to claim 3, wherein said evaluation made by said other client with respect to said article comprises a multivalued quantitative value.

8. A method according to claim 4, wherein said evaluation made by said other client with respect to said article comprises a multivalued quantitative value.

9. A method according to claim 3, further comprising the step of:
giving said other client which has evaluated the article contributed to the bulletin board, said benefit depending on the number of times that said evaluation has been entered.

10. A method according to claim 4, further comprising the step of:
giving said other client which has evaluated the article contributed to the bulletin board, said benefit depending on the number of times that said evaluation has been entered.

11. A method according to claim 9, further comprising the step of:
giving said benefit to clients, among said plurality of clients, which have entered said evaluation a number of times which is equal to or greater than a predetermined number.

12. A method according to claim 10, further comprising the step of:
giving said benefit to clients, among said plurality of clients, which have entered said evaluation a number of times which is equal to or greater than a predetermined number.

13. A method according to claim 5, further comprising the steps of:
totaling said quantatitive value over a predetermined period; and
giving said client said benefit depending on the totaled quantatitive value.

14. A method according to claim 6, further comprising the steps of:
totaling said quantatitive value over a predetermined period; and
giving said client said benefit depending on the totaled quantatitive value.

15. A method according to claim 5, further comprising the steps of:
evaluating the article by voting for or against the article; and
giving said client said benefit depending on the number of votes for the articles from the clients.

16. A method according to claim 6, further comprising the steps of:
evaluating the article by voting for or against the article; and
giving said client said benefit depending on the number of votes for the articles from the clients.

17. A method according to claim 1, wherein said benefit comprises points that can be added.

18. A method according to claim 2, wherein said benefit comprises points that can be added.

19. A method according to claim 1, further comprising the step of:
placing information other than the article contributed by the client on the bulletin board.

20. A method according to claim 2, further comprising the step of:
placing information other than the article contributed by the client on the bulletin board.

21. A method according to claim 1, further comprising the step of:
providing a plurality of bulletin boards for respective predetermined categories.

22. A method according to claim 2, further comprising the step of:
providing a plurality of bulletin boards for respective predetermined categories.

23. A method according to claim 1, further comprising the step of:
displaying the bulletin board following a page for purchasing merchandise.

24. A method according to claim 2, further comprising the step of:
displaying the bulletin board following a page for purchasing merchandise.

25. A method of attracting customers in a bulletin board supplied from a server connected to a plurality of clients, comprising the step of:
displaying an evaluation of an article which has been contributed to the bulletin board by a client, by another client.

26. A method of attracting customers in a bulletin board, comprising the steps of:
storing an article contributed to a bulletin board supplied to a client in a server from a plurality of clients;
supplying the article stored in the server to another client; and
displaying an evaluation of said article by another client.

27. A method according to claim 25, further comprising the step of:
displaying the number of points assigned to said client depending on the evaluation by the other client of the article which has been contributed to the bulletin board by said client.

28. A method according to claim 26, further comprising the step of:
displaying the number of points assigned to said client depending on the evaluation by the other client of the article which has been contributed to the bulletin board by said client.

29. A system using a bulletin board, comprising:
a plurality of clients;
an information transmitting server connected to said clients via the Internet, for supplying a bulletin board to said clients and giving a client a predetermined benefit depending on the level of a reaction from another client with respect to an article which has been contributed to the bulletin board by said client; and
a customer information managing server for managing information of the clients including said benefit.

30. A system according to claim 29, wherein said reaction from the other client serves as a criterion to give the client said benefit comprises an evaluation made by said other client with respect to said article.

31. A system according to claim 29, wherein said criterion to give the client said benefit comprises a quantitative value depending on the number of answers from clients which have evaluated the article.

32. A system according to claim 30, wherein said evaluation made by said other client with respect to said article comprises a multivalued quantitative value.

33. A system according to claim 30, wherein said information transmitting server comprises means for giving said other client which has evaluated the article, said benefit depending on the number of times that said evaluation has been entered.

34. A system according to claim 33, wherein said information transmitting server comprises means for giving said benefit to clients, among said plurality of clients, which have entered said evaluation a number of times which is equal to or greater than a predetermined number.

35. A system according to claim 31, wherein said information transmitting server comprises means for totaling said quantatitive value over a predetermined period, and giving said client said benefit depending on the totaled quantatitive value.

36. A system according to claim 30, wherein said information transmitting server comprises means for rejecting an evaluation of said article from the client which has contributed the article.

37. A system according to claim 36, wherein said information transmitting server comprises means for rejecting an evaluation of the same article from the same client.

38. A system according to claim 32, wherein said other client comprises means for evaluating the article by voting for or against the article, and said information transmitting server comprises means for giving said client said benefit depending on the number of votes for the articles from the clients.

39. A system according to claim 29, wherein said information transmitting server comprises means for giving said client points that can be added as said benefit.

40. A system according to claim 29, wherein said information transmitting server comprises means for placing information other than the article contributed by the client on the bulletin board.

41. A system according to claim 29, wherein said information transmitting server comprises means for providing a plurality of bulletin boards for respective predetermined categories.

42. A system according to claim 29, wherein said information transmitting server comprises means for supplying a page with the bulletin board displayed therein in combination with a page for purchasing merchandise.

43. A system using a bulletin board, comprising:
a plurality of clients; and
an information transmitting server connected to said clients via the Internet, for supplying a bulletin board to said clients and displaying an evaluation of an article contributed by a client to said bulletin board by another client, on said client.

44. A system according to claim 43, wherein said information transmitting server comprises means for displaying, on said client, the number of points assigned to said client depending on the evaluation by the other client of the article which has been contributed to the bulletin board by said client.

45. A server connected to a plurality of clients via the Internet, for supplying a bulletin board to said clients and giving a client a predetermined benefit depending on the level of a reaction from another client with respect to an article which has been contributed to the bulletin board by said client.
